(19) United States
(12) Patent Application Publication
(10) Pub. No.: US 2005/0243868 A1
(43) Pub. Date: Nov. 3, 2005

(54) Data transmission method adapted to network system for broadcasting distribution of streaming contents

(75) Inventor: Kazushi Tamai, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Hamamatsu-shi (JP)

(21) Appl. No.: 11/114,577

(22) Filed: Apr. 26, 2005

(30) Foreign Application Priority Data
Apr. 28, 2004 (JP) 2004-134115

(51) Int. Cl. H04L 12/66

(52) U.S. Cl. 370/476

(57) ABSTRACT

A data transmission method adapted to a network system for interconnecting a server with a receiver terminal via the Internet, in which a plurality of frames f(1), f(2), . . . , and f(u) are extracted from streaming contents and are distributed to a plurality of packets p(1), p(2), . . . , and p(u) by interleaving, wherein a plurality of data included in the frame f(u) represented by a matrix of m×n are distributed to a plurality of packets p(u) to p(k+u−1) (where ‘u’ and ‘k’ designate integers), whereby any one of the packets includes first data of each frame, so that it is possible to start reproducing the streaming contents after completely receiving last data of each frame without discarding packets. This noticeably reduces a time lag between the reception start timing and the reproduction start timing.

### BACKGROUND OF THE INVENTION

1. Field of the Invention

This invention relates to data transmission methods adapted to network systems in which streaming contents such as audio data are subjected to broadcasting distribution via networks such as the Internet.

This application claims priority on Japanese Patent Application No. 2004-134115, the content of which is incorporated herein by reference.

2. Description of the Related Art

Recently, various types of Internet broadcasting systems have been developed and put into practical uses as disclosed in Japanese Patent Application Publication No. 2002-202950, which teaches an Internet broadcasting station system. In streaming contents distribution on the Internet, reproduction of streaming contents may be broken due to burst error caused by the lack or loss of packets, wherein sound is unexpectedly skipped without being reproduced. In order to avoid the occurrence of the aforementioned event, interleaving is performed such that sequential streaming data are alternated in order and are distributed to a plurality of packets, which are then subjected to transmission.

The conventionally known interleaving system will be described in conjunction with FIGS. 8A and 8B, wherein sequential streaming data are divided into a plurality of frames each having a prescribed length, to which a plurality of packets are assigned in a traverse manner as shown in FIG. 8A. That is, a plurality of packets are transmitted by way of a plurality of frames, wherein even when one packet is lost in transmission, a burst error may not occur in streaming data; in other words, a random error may occur in each frame.

When packets are lost in transmission, the interleaving system changes the order of sequential streaming data so as to restore original frames, so that a burst error is displaced with a random error. This makes it possible to perform error correction, whereby it is possible to avoid the occurrence of sound skipping.

The conventionally known interleaving system is designed such that as shown in FIGS. 8A and 8B, a plurality of frames correspond to a plurality of packets, whereby it is possible to perform decoding on fames upon the reception of packet groups (each designating a collection of packets) starting from their first packets. Even when the reception is started in the middle of a prescribed packet group so as to completely receive the last packet thereof, this packet group is discarded; then, ‘effective’ reception is started with respect to the next packet group starting from its first packet. This requires a relatively long time (e.g., ten seconds or more) between the reception start timing and the reproduction start timing.

### SUMMARY OF THE INVENTION

It is an object of the invention to provide a data transmission method that can reduce a time lag between the reception start timing and the reproduction start timing in streaming contents broadcasting distribution using networks.

A data transmission system according to this invention includes a server coupled with a storage for storing streaming contents (e.g., audio contents), which is connected with a plurality of receiver terminals via a prescribed network such as the Internet.

According to this invention, a plurality of frame data regarding frames f(1), f(2), . . . , f(u), which are sequentially supplied to a data transmission system, are subjected to sequential transmission onto a prescribed network such as the Internet in the form of packets p(1), p(2), . . . , p(u), wherein a plurality of data included in the frame f(u) are distributed (or allocated) into packets p(u) to p(k+u−1).

Specifically, a plurality of data of each frame are arranged in a matrix form consisting of m lines and n columns (where ‘m’ and ‘n’ are integers), wherein error correction codes are added to frame data with respect to lines and columns respectively, whereby data located at coordinates of line i and column j in the frame f(u) is allocated to a packet p(u+(j−1)b+i), which is then subjected to transmission.

In the above, ‘b’ designates a difference between adjacent data (e.g., d(1) and d(2)) in each frame, which matches a prescribed number of packets. That is, b=m when each data of each frame is independently allocated to each single packet. When b<m, a plurality of data of the same frame are distributed to a plurality of packets.

Data located at coordinates of line i and column j of the frame f(u) can be allocated to coordinates of line i and column j of a packet p(u−1+(j−1)b+i).

In addition, a plurality of data included in the frame f(1) are distributed to a plurality of packets p(1) to p(k); a plurality of data included in the frame f(2) are distributed to a plurality of packets p(2) to p(k+1); and a plurality of data included in the frame f(u) are distributed to packets p(u) to p(k+u−1). That is, a plurality of data included in each frame are sequentially distributed to a series of packets in a prescribed order, wherein a previous frame to be reproduced previously is allocated to a previous packet to be previously transmitted.

Due to the aforementioned interleaving method, any packet includes first data of a prescribed frame, whereby upon completion of reception of the last packet including last data of a prescribed frame, it is possible to start reproducing streaming data (e.g., audio contents). Thus, even when reception is started with a prescribed packet, it is possible to start reproducing a prescribed frame whose first data is allocated to the prescribed packet without discarding packets sequentially received by the receiver terminal; hence, it is possible to reduce a time lag (or a wait time) between the reception start timing (for receiving packets representing streaming contents) and the reproduction start timing.

Furthermore, a plurality of data located at different coordinates in the matrix of the frame f(1) are respectively allocated to different packets in such a way that data of line 1 and column 1 is allocated to p(1); data of line 2 and column 1 is allocated to p(2); data of line m and column 1 is allocated to p(m); data of line 1 and column 2 is allocated to p(b+1); data of line 2 and column 2 is allocated to p(b+2); data of line m and column 2 is allocated to p(b+m); data of line 1 and column n is allocated to p((n−1)b+1); data of line 2 and column n is allocated to p((n−1)b+2); and data of line m and column n is allocated to p((n−1)b+m), where (n−1)b+m=k.

A plurality of data located at different coordinates in the matrix of the frame f(2) are respectively allocated to different packets in such a way that data of line 1 and column 1 is allocated to p(2); data of line 2 and column 1 is allocated to p(3); data of line m and column 1 is allocated to p(m+1); data of line 1 and column 2 is allocated to p(b+2); data of line 2 and column 2 is allocated to p(b+3); data of line m and column 2 is allocated to p(b+m+1); data of line 1 and column n is allocated to p((n−1)b+2); data of line 2 and column n is allocated to p((n−1)b+3); and data of line m and column n is allocated to p((n−1)b+m+1).

A plurality of data located at different coordinates in the matrix of the frame f(u) are respectively allocated to different packets in such a way that data of line 1 and column 1 is allocated to p(u+1); data of line 2 and column 1 is allocated to p(u+2); data of line m and column 1 is allocated to p(u+m); data of line 1 and column 2 is allocated to p(u+b+1); data of line 2 and column 2 is allocated to p(u+b+2); data of line m and column 2 is allocated to p(u+b+m); data of line 1 and column n is allocated to p(u+(n−1)b+1); data of line 2 and column n is allocated to p(u+(n−1)b+2); and data of line m and column n is allocated to p(u+(n−1)b+m).

When frame data are distributed to packets, they are changed in order, wherein even when a plurality of packets are consecutively lost during transmission, the receiver terminal restores the corresponding frame data with a random error, which improves the resistance against the lack of frames.

A plurality of data included in each frame having a matrix form are distributed to a plurality of packets each having a matrix form such that data located at coordinates (i,j) in the matrix of each frame is allocated to the same coordinates in the matrix of the corresponding packet. Thus, even when a plurality of data included in different frames are allocated to the same packet, no data overlap each other at the same coordinates in the matrix of the packet.

A plurality of data included in frames are subjected to distribution along lines of matrices of packets, wherein consecutive data aligned in the same column of the matrix of a frame are each distributed to packets with a difference b therebetween. When such a distribution difference b is reduced as b<m (where ‘m’ designates the number of lines included in each matrix), it is possible to reduce the range of packets, to which a plurality of data included in each frame are distributed, without reducing error resistance in transmission. Hence, it is possible to reduce a time lag between the reception start timing (for receiving packets) and the reproduction start timing.

As a result, even when the receiver terminal starts receiving any one of the packets, which are sequentially transmitted thereto and to which a plurality of frame data are distributed by way of interleaving, it is possible to start restoring original frame data (or to start reproducing streaming contents) within a very short time lag without discarding packets received thereby.

### BRIEF DESCRIPTION OF THE DRAWINGS

These and other objects, aspects, and embodiments of the present invention will be described in more detail with reference to the following drawings, in which:

FIG. 1 is a block diagram showing the overall constitution of an audio distribution system realizing a data transmission method in accordance with a preferred embodiment of the invention;

FIG. 2A diagrammatically shows an arrangement of packets in a matrix form adapted to the audio distribution system;

FIG. 2B diagrammatically shows an arrangement of frame data in a matrix form adapted to the audio distribution system;

FIG. 3A diagrammatically shows an arrangement of frames each illustrated in a matrix form subjected to transmission;

FIG. 3B diagrammatically shows an arrangement of packets into which a plurality of data regarding each frame are appropriately diffused for the purpose of transmission;

FIG. 4 diagrammatically shows a method for how to diffuse a plurality of bytes regarding each frame into different packets;

FIG. 5A diagrammatically shows a diffusing range of consecutive frame data allocated to consecutive packets in the embodiment;

FIG. 5B diagrammatically shows a diffusing range of consecutive frame data allocated to consecutive packets in the conventionally known interleaving system;.

FIG. 6 is a flowchart showing sequential processing executed in a server shown in FIG. 1;

FIG. 7A is a flowchart showing reception control operation of a receiver terminal shown in FIG. 1;

FIG. 7B is a flowchart showing reproduction (or decoding) operation of the receiver terminal;

FIG. 8A diagrammatically shows the relationship between packets and frames adopted in the conventionally known interleaving system; and

FIG. 8B diagrammatically shows assignments between packets and frames in transmission.

### DESCRIPTION OF THE PREFERRED EMBODIMENT

This invention will be described in further detail by way of examples with reference to the accompanying drawings.

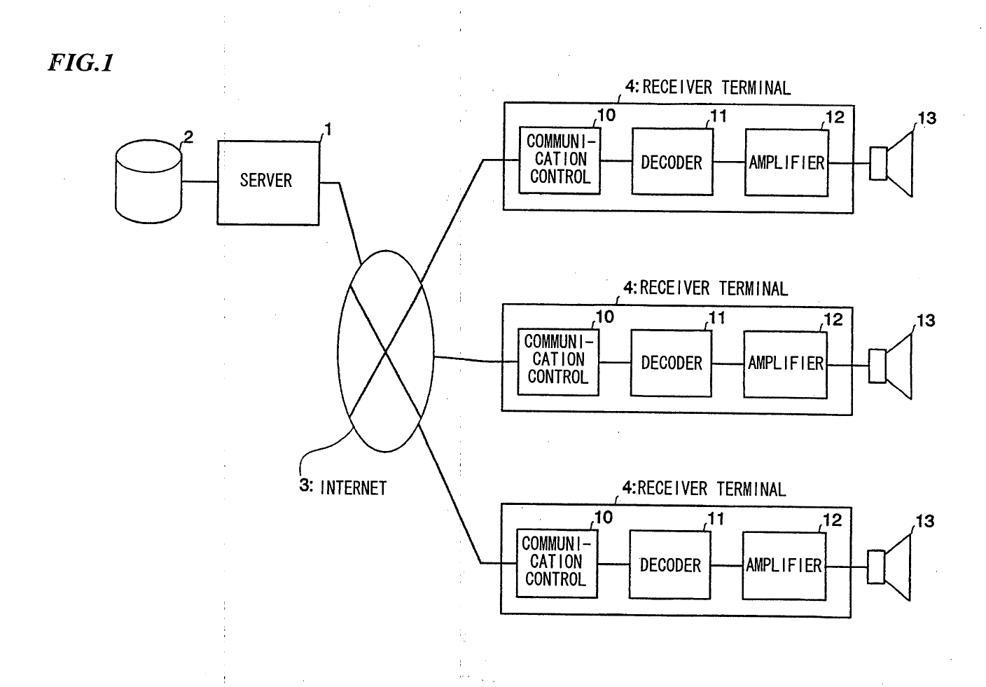

FIG. 1 is a block diagram showing the overall constitution of an audio distribution system in accordance with a preferred embodiment of the invention. A server 1 is equipped with a storage 2 for storing and accumulating various data regarding audio contents. The storage 2 is configured using hard disks, for example. The server 1 is connected with an Internet 3, via which audio contents are subjected to streaming broadcasting (or broadcasting distribution).

In the broadcasting distribution, streaming data strings are divided into a plurality of frames each having a prescribed length expressed as (m−1)×(n−1) bytes. In addition, error correction codes are added to frames, which are then subjected to interleaving and converted into packets. The present embodiment uses a prescribed communication protocol that performs ‘order control’ but does not perform ‘retransmission control’ regarding packets that are lost during transmission.

The Internet 3 is connected with a plurality of receiver terminals 4, each of which receives and reproduces audio contents, which the server 1 outputs to the Internet 3 in the streaming form.

Each of the receiver terminals 4 includes a communication control 10, a decoder 11, an amplifier 12, and a speaker 13. The communication control 10 functions to control access to the Internet 3, and it receives packets transmitted thereto in accordance with the aforementioned protocol in the streaming broadcasting (or broadcasting distribution). The decoder 11 decodes streaming data included in packets received by the communication control 10 so as to restore original audio data strings corresponding to audio contents. The decoder 11 includes a digital-to-analog converter (not shown), which converts audio data strings into analog audio signals. The amplifier 12 amplifies audio signals output from the decoder 11 so as to drive the speaker 13 to produce the corresponding sound.

In the above, the streaming output of the server 1 is not necessarily limited to audio contents, so that any type of contents, such as visual contents, can be used. Contents are not necessarily stored in the storage 2; hence, it is possible to use ‘live’ sound and video picked up using a microphone and a camera in real time.

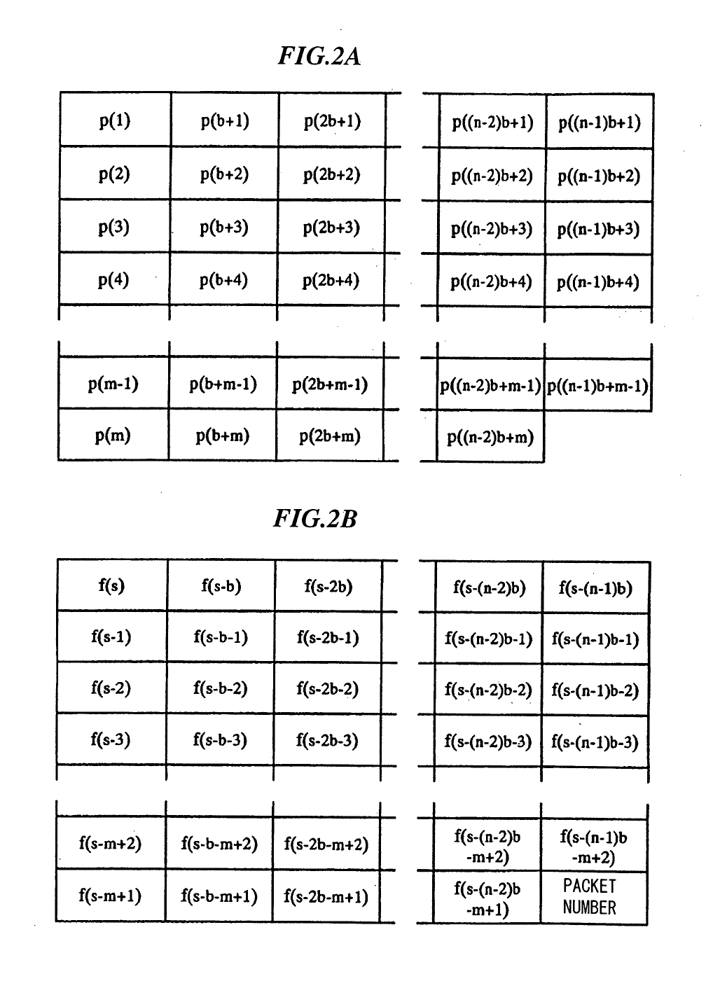

Next, the interleaving system adapted to the streaming broadcasting will be described with reference to FIGS. 2A, 2B, 3A, 3B, 4, 5A, and 5B.

FIG. 2A shows frames, corresponding to data units used for the transformation of streaming data strings into packets, which are appropriately divided in the present embodiment. FIG. 2B shows a single packet that is configured by a plurality of frame data diffused in a plurality of frames respectively.

As shown in FIG. 2A, the server 1 divides streaming data strings into frames each configured by (m−1)×(n−1) bytes, thus producing frame data. Frame data are arranged in a matrix consisting of (m−1)×(n−1), wherein they are arranged horizontally along lines; that is, frame data belonging to line 1 are consecutively arranged in a prescribed order ranging from column 1 to column (n−1); frame data belonging to line 2 are consecutively arranged in a prescribed order ranging from column 1 to column (n−1); . . . ; and frame data belonging to line (m−1) are consecutively arranged in a prescribed order ranging from column 1 to column (n−1). In addition, error correction codes (each consisting of a single byte) are added with respect to lines and columns respectively. Thus, it is possible to form a matrix of m×n bytes.

Frame data are subjected to interleaving and are thus diffused into a plurality of packets, which are then subjected to transmission. In the matrix shown in FIG. 2A, each rectangular block designates a single byte to which a prescribed packet number (or a prescribed packet order) is assigned. In the matrix shown in FIG. 2B, each rectangular block designates a single byte, which is distributed to a prescribed frame and to which a prescribed frame number (or a prescribed frame order) is assigned.

According to the aforementioned interleaving system, ‘consecutive’ packets p(1) to p(m) are allocated to blocks ranging from line 1 to line m with respect to column 1 in the matrix shown in FIG. 2A. Similarly, ‘consecutive’ packets p(b+1) to p(b+m) are allocated to blocks ranging from line 1 to line m with respect to column 2. That is, these packets are diffused in such a way that consecutive bytes are read out vertically in the matrix shown in FIG. 2A, wherein consecutive bytes belonging to column 1 are read out from line 1 to line m; consecutive bytes belonging to column 2 are read out from line 1 to line m; . . . ; and consecutive bytes belonging to column n are read out from line 1 to line m. As described above, streaming data are arranged horizontally in the matrix; hence, sequential streaming data are diffused into packets and are appropriately changed in order.

As shown in FIG. 2B, the data portion of a packet has the configuration identical to the configuration of frame data, which consists of m×n bytes. Each of frame data distributed to packets is located at coordinates identical to coordinates of the corresponding packet. That is, a specific byte located at coordinates of line i and column j in a matrix form of a frame is located at coordinates of line i and column j in a matrix form in which packets are diffused.

In each frame, a byte located at coordinates of line m and column n is blank in the matrix shown in FIG. 2A. In each packet, a byte located at coordinates of line m and column n designates a packet number in the matrix shown in FIG. 2B. Prescribed numbers ranging from ‘0’ to ‘255’ are assigned to packets in a cyclic manner in accordance with a prescribed transmission order. That is, the same numbers are repeatedly assigned to every other 256 packets. It is unlikely that packets are accidentally changed in order by every other 256 packets; hence, it is possible to accurately discriminate the order of packets at the reception side in consideration of packet numbers assigned to respective bytes.

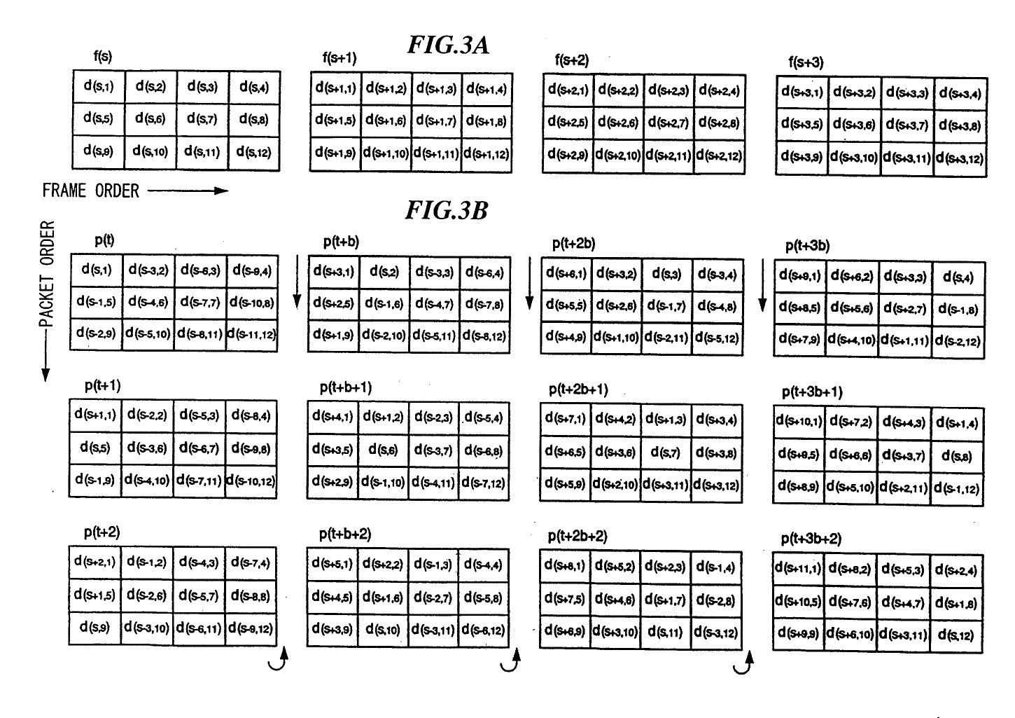

Next, a diffusing order of frame data and arrangement of frame data within packets will be described with reference to FIGS. 3A and 3B. For the sake of convenience, each matrix consists of three lines by four columns. FIG. 3A shows a consecutive arrangement of four frame data, each of which is expressed as a matrix of three lines by four columns. FIG. 3B shows twelve packets to which frame data regarding a specific frame ‘s’ are distributed, wherein a reproduction order of frame data is defined in the order from the left to the right, and a transmission order of packets is defined in the order from the left to the right and in the order from the upper to the lower.

Specifically, data d(s,1) located at coordinates of line 1 and column 1 in a frame f(s) (see the leftmost frame in FIG. 3A) is located at coordinates of line 1 and column 1 in a packet p(t) (see the upper-leftmost packet in FIG. 3B). Similarly, data d(s,5) located at coordinates of line 2 and column 1 in the frame f(s) is located at coordinates of line 2 and column 1 of a packet p(t+1); data d(s,9) located at coordinates of line 3 and column 1 in the frame f(s) is located at coordinates of line 3 and column 1 of a packet p(t+2); data d(s,2) located at coordinates of line 1 and column 2 of the frame f(s) is located at coordinates of line 1 and column 2 of a packet p(t+b); data d(s,6) located at coordinates of line 2 and column 2 of the frame f(s) is located at coordinates of line 2 and column 2 of a packet p(t+b+1); and data d(s,10) located at coordinates of line 3 and column 2 of the frame f(s) is located at coordinates of line 3 and column 2 of a packet p(t+b+2).

In addition, data d(s,3) located at coordinates of line 1 and column 3 of the frame f(s) is located at coordinates of line 1 and column 3 of a packet p(t+2b); data d(s,7) located at coordinates of line 2 and column 3 of the frame f(s) is located at coordinates of line 2 and column 3 of a packet p(t+2b+1); data d(s,11) located at coordinates of line 3 and column 3 of the frame f(s) is located at coordinates of line 3 and column 3 of a packet p(t+2b+2); data d(s,4) located at coordinates of line 1 and column 4 of the frame f(s) is located at coordinates of line 1 and column 4 of a packet p(t+3b); data d(s,8) located at coordinates of line 2 and column 4 of the frame f(s) is located at coordinates of line 2 and column 4 of a packet p(t+3b+1); and data d(s,12) located at coordinates of line 3 and column 4 of the frame f(s) is located at coordinates of line 3 and column 4 of a packet p(t+3b+2).

As described above, a plurality of data regarding the frame f(s) are distributed to packets p(t) to p(t+3b+2), wherein the transmission order thereof is expressed using reference symbol d(s,i) in which a variable i is sequentially changed in the order of i=1, 5, 9, 2, 6, 10, 3, 7, 11, 4, 8, and 12. That is, the transmission order of streaming data is changed at random, whereby in an event in which a plurality of packets are consecutively lost, the audio distribution system can handle such an even as a random error.

In each frame having a matrix form shown in FIG. 3A, horizontally adjacent data (e.g., d(s,1) and d(s,2) in the frame f(s)) are located with a prescribed difference ‘b’ therebetween. These data are distributed to packets as shown in FIG. 3B in such a way that the difference b matches a prescribed number ‘m’ of packets arranged in each column in FIG. 3B. That is, a plurality of data regarding the frame f(s) shown in FIG. 3A are distributed to different packets as shown in FIG. 3B.

Of course, it is possible to modify b to be smaller than m. For example, when b is set to ‘2’, the packet p(t+2) matches the packet p(t+b) so that both of the data d(s,9) and d(s,2) are allocated to the same packet; the packet p(t+b+2) matches the packet p(t+2b) so that both of the data d(s,10) and d(s,3) are allocated to the same packet; and the packet p(t+2b+2) matches the packet p(t+3b) so that both of the data d(s,11) and d(s,4) are allocated to the same packet.

As described above, by reducing b to be smaller than m, bytes regarding column i ranging from line b+1 to line m overlap with bytes regarding column i+1 ranging from line 1 to line m−b (where i is an integer) in the matrix form of each frame, wherein they are allocated to packets p((i+1)·b+1) to p(i·m) respectively.

When b matches m, a plurality of bytes regarding each frame are distributed to different packets respectively; hence, it is possible to realize a highest resistance against the lack (or loss) of packets during transmission (or reception), whereas m×n bytes are required to complete the transmission (or reception) of one frame data. In contrast, by reducing b to be smaller than m, a plurality of data (e.g., two data) regarding each frame should be allocated to the same packet, which may slightly reduce the resistance against the lack of packets during transmission (or reception), whereas (n−1)b+m bytes may meet the complete transmission (or reception) of one frame data. That is, by reducing b in comparison with m, it is possible to reduce the number of packets required for the restoration of one frame data at the reception side, which realizes rapid reproduction to be started.

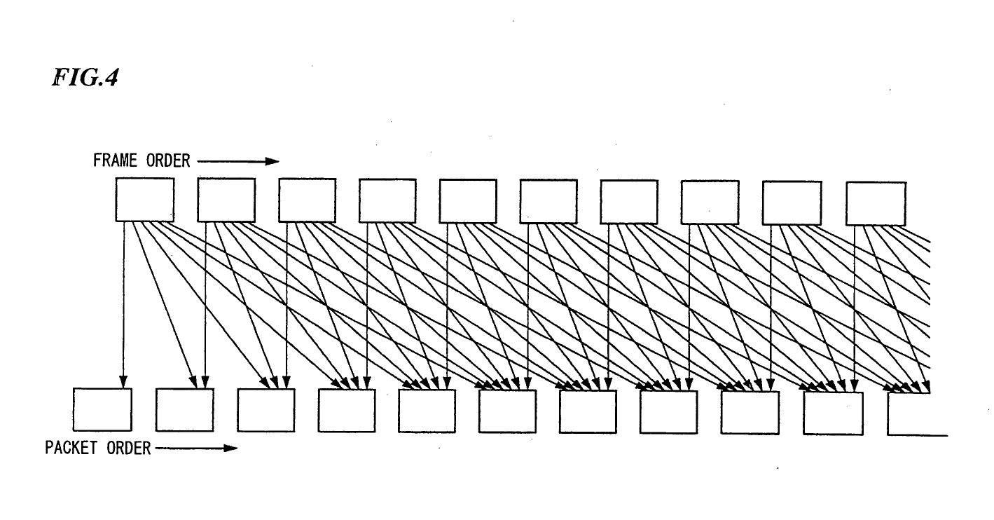

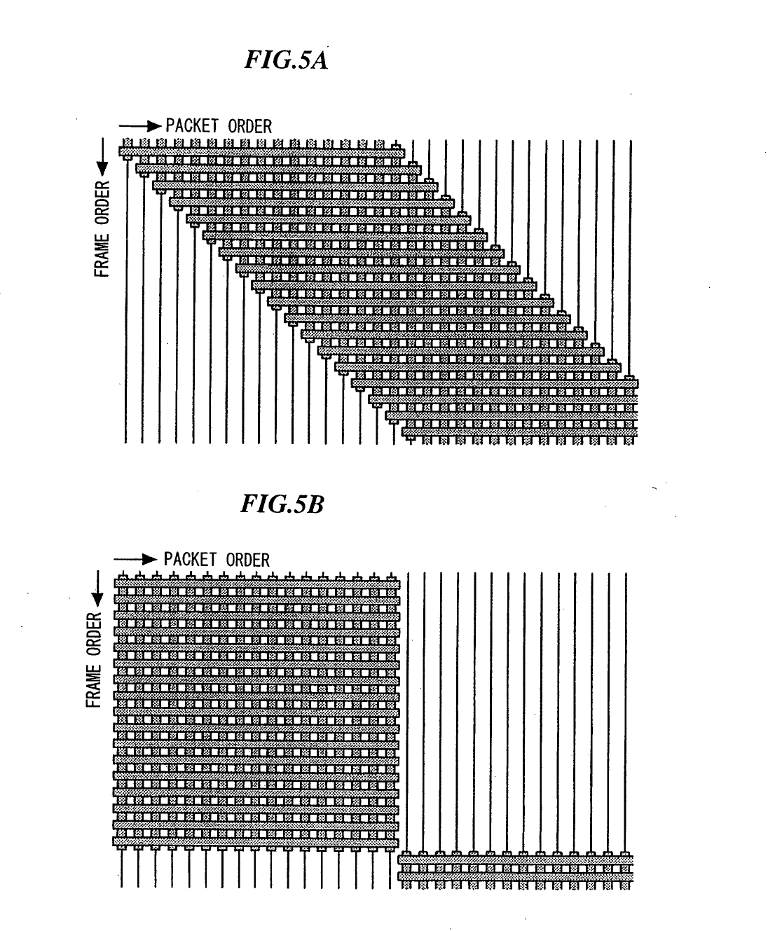

FIG. 4 diagrammatically shows the aforementioned method how to diffuse a plurality of bytes regarding each frame into different packets. FIG. 5A diagrammatically shows a diffusing range of consecutive frame data allocated to consecutive packets (ranging from a transmission start packet to a transmission end packet) in accordance with the present embodiment. FIG. 5B diagrammatically shows a diffusing range of consecutive frame data allocated to consecutive packets in accordance with the conventionally known interleaving system.

According to the interleaving method adapted to the present embodiment, consecutive frame data are sequentially distributed to consecutive packets in a prescribed direction as shown in FIGS. 4 and 5A, wherein transmission is started such that a previous frame (i.e., a frame to be previously reproduced) is allocated to a previous packet (i.e., a packet to be previously transmitted), and transmission is ended such that a previous frame is allocated to a previous packet.

In the aforementioned interleaving method, each of the packets contains frame data that should be started in transmission, whereby upon completion of reception of frame data, in other words, upon completion of reception of the last packet (corresponding to the end of transmission) in which frame data are diffused, it is possible to start the reproduction of streaming data (i.e., audio contents).

By sequentially receiving packets, it is possible to complete the reception of the following frame data; hence, it is possible to consecutively perform the reproduction of streaming data.

In contrast to the present embodiment, according to the conventionally known interleaving method shown in FIG. 5B, a plurality of frame data are diffused in the same packet; therefore, when reception is started from an ‘intermediate’ packet (denoted as a packet W), all data of this packet are discarded, so that ‘effective’ reception is started from first data of the next packet. That is, compared with the present embodiment, the conventionally known interleaving method suffers from an increasing time lag between the reception start timing and reproduction start timing.

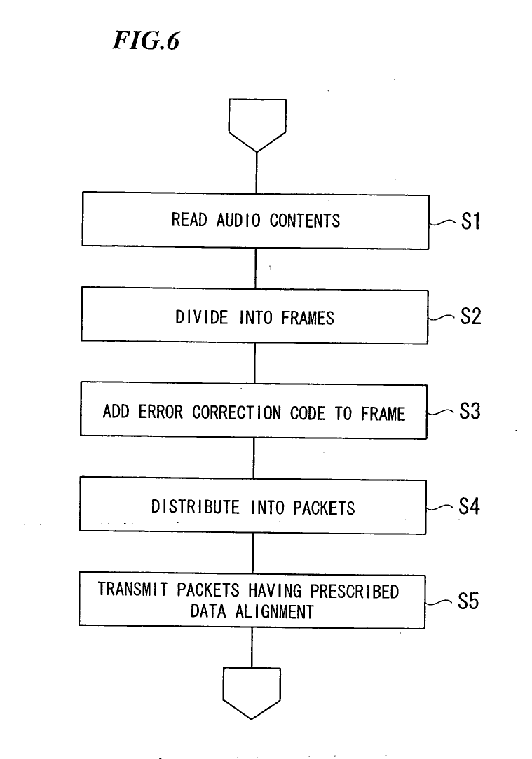

FIG. 6 is a flowchart showing a part of processing executed in the server 1 according to the present embodiment. Actually, streaming distribution processing is realized by parallel processing using a plurality of processes, wherein the flowchart of FIG. 6 describes sequential processing regarding the sequence of data subjected to processing.

First, the server 1 reads audio contents from the storage 2 in step S1. In step S2, the audio contents are divided into a plurality of frame data of (m−1)×(n−1) bytes. In step S3, error correction codes are added to frame data, which are aligned in a matrix, with respect to lines and columns respectively. In step S4, frame data added with error correction codes are distributed to prescribed packets. In step S5, packets whose data are completed are sequentially transmitted onto the Internet 3 at prescribed timings in accordance with the prescribed communication protocol regarding streaming distribution.

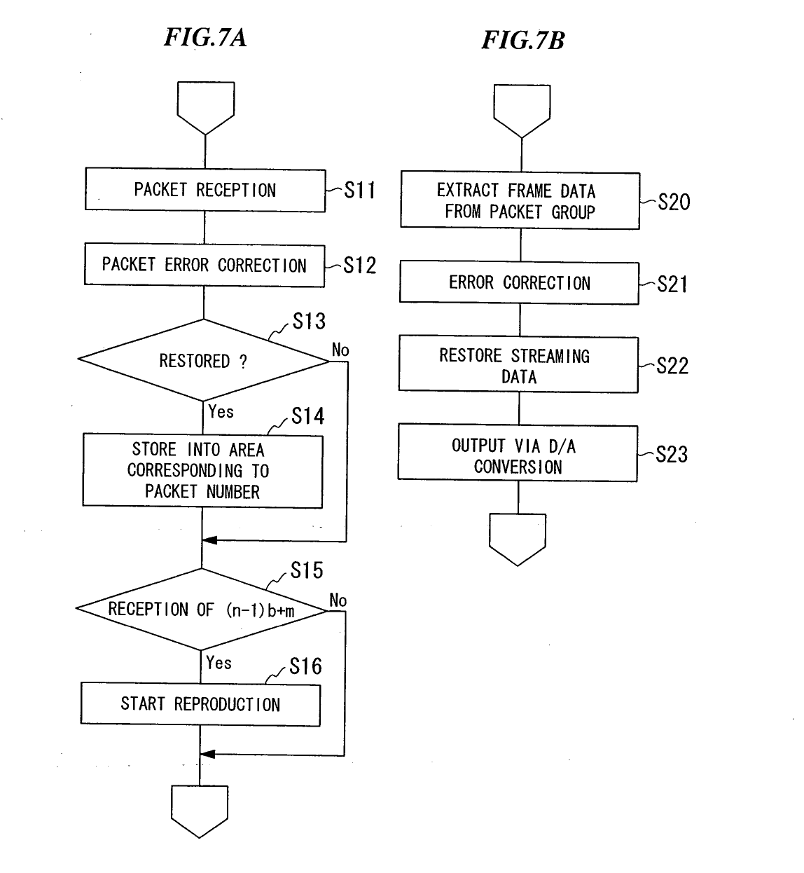

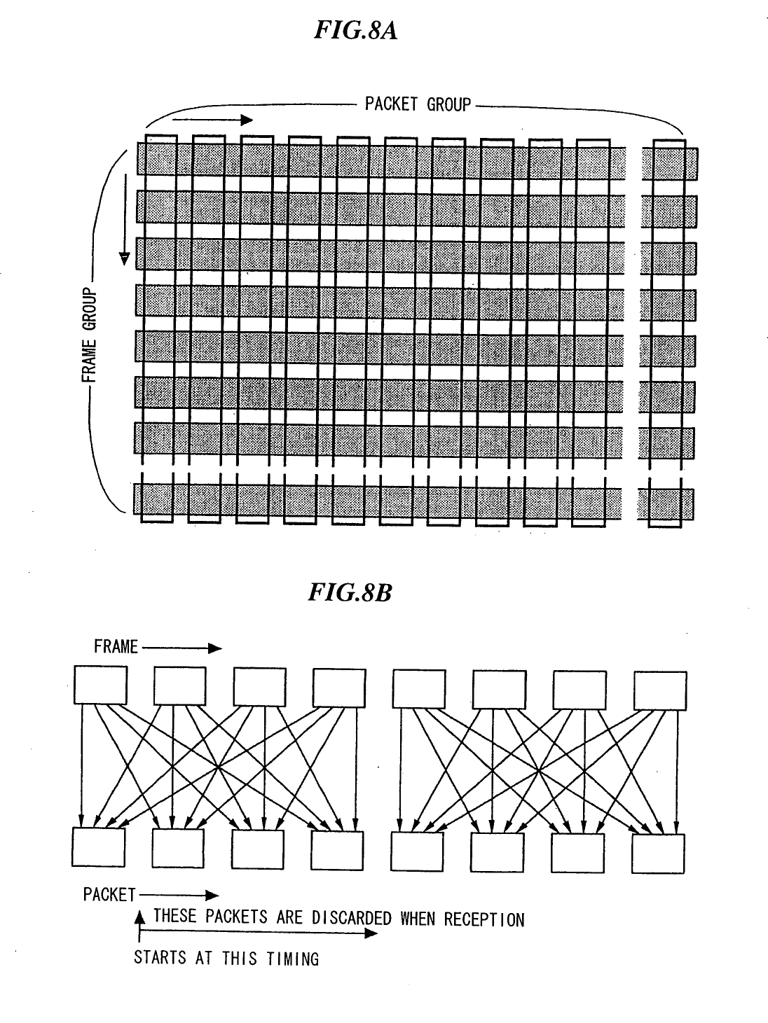

FIGS. 7A and 7B are flowcharts showing the overall operation of the receiver terminal 4, wherein the flowchart of FIG. 7A shows reception control operation, and the flowchart of FIG. 7B shows reproduction (or decoding) operation.

In step S11 shown in FIG. 7A, the receiver terminal 4 receives packets corresponding to streaming data, which are transmitted thereto via the Internet 3. In step S12, received packets are subjected to error correction in response to error correction codes, which are included in packets, and in accordance with error correction functions included in the communication protocol. When error correction is completed (see step S13), the receiver terminal 4 reads packet numbers included in packets (see FIG. 2B), so that packets are temporarily stored in a buffer (or buffer areas) in correspondence with packet numbers thereof in step S14. A series of the aforementioned operations are repeatedly performed every time the receiver terminal 4 receives packets.

After completion of reception of ‘(n−1)b+m’ packets (which may include damaged or lost packets), the receiver terminal 4 issues a reproduction start instruction for starting reproduction operation thereof in step S16. The receiver terminal 4 repeatedly performs the aforementioned steps S11 to S14 every time it receives packets.

The buffer is commonly accommodated to the communication control 10 and the decoder 11, wherein the storage capacity thereof is equal to (n−1)b+m bytes or more, so that it stores a prescribed number of packets in a cyclic manner. That is, in step S14, a new packet is written over an old packet. In order to restore original frame data by canceling interleaving in the reproduction operation, the receiver terminal 4 requires (n−1)b+m packets, which may include a small number of packets whose errors can be corrected.

FIG. 7A shows the reproduction operation performed in the receiver terminal 4. Upon issuance of a reproduction start instruction in the reception control operation shown in FIG. 7A, the receiver terminal 4 starts the reproduction operation, wherein it extracts data from a plurality of packets accumulated in the buffer so as to restore original frame data in step S20. For example, the receiver terminal 4 extracts data d(i,j) located at coordinates of line i and column j in a certain frame such that it extracts data located at coordinates (i,j) in a packet p(j−1)b+i), wherein data d(1,1) located at coordinates of line 1 and column 1 of the frame is written into a packet p(1). The aforementioned operation is repeatedly performed with respect to d(1,1) to d(m,n), thus restoring the frame. Herein, bytes written in lost packets are not restored.

Then, lost data are restored using error correction codes, which are added to frame data of a matrix form with respect to lines and columns respectively. In step S21, original data are restored in accordance with error correction functions originally applied to streaming data. In step S22, restored frame data are handled as a series of consecutive data so as to restore original streaming data, which are input into D/A converters so as to reproduce analog audio signals.

The present embodiment is characterized in that error correction codes are added to frame data, which are formed in a matrix, with respect to lines and columns respectively. Thus, it is possible to improve the resistance against errors in transmission. In addition, the present embodiment adopts a special data distribution method in which frame data are not distributed in the original order thereof but in which frame data having matrix forms are horizontally aligned in conformity with a sequence of frames so that they are read out vertically and are sequentially distributed to packets. This improves random distribution of frame data into packets, whereby even when packets are lost during transmission, it is possible to noticeably improve an ability of restoring original data, which is actually proved through experiments.

As this invention may be embodied in several forms without departing from the spirit or essential characteristics thereof, the present embodiment is therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

1. A data transmission method in which a plurality of frames f(1), f(2), . . . , and f(u) are distributed to a plurality of packets p(1), p(2), . . . , and p(u), which are then transmitted via a network, wherein a plurality of data included in the frame f(u) are distributed to a plurality of packets p(u) to p(k+u−1) (where ‘u’ and ‘k’ designate integers).

2. A data transmission method according to claim 1, wherein a plurality of data included in each frame are arranged in a matrix of m×n (where ‘m’ and ‘n’ designate integers selected in advance), so that data located at coordinates of line i and column j of the frame f(u) (where ‘i’ designates an integer not greater than ‘m’, and ‘j’ designates an integer not greater than ‘n’) is allocated to a packet p(u+(j−1)b+i) (where ‘b’ designates an integer representing a difference between adjacent data within the plurality of data of each frame and matching a prescribed number of packets).

3. A data transmission system according to claim 2, wherein a plurality of data included in each packet are arranged in a matrix of m×n, so that data located at coordinates of line i and column j of the frame f(u) is allocated to coordinates of line i and column j of a packet p(u−1+(j−1)b+i).

4. A server adapted to a network system, wherein a plurality of frames f(1), f(2), . . . , and f(u) are extracted from streaming contents and are distributed to a plurality of packets p(1), p(2), . . . , and p(u), and wherein a plurality of data included in the frame f(u) are distributed to a plurality of packets p(u) to p(k+u−1) (where ‘u’ and ‘k’ designate integers).

5. The server adapted to a network system according to claim 4, wherein a plurality of data included in each frame are arranged in a matrix of m×n (where ‘m’ and ‘n’ designate integers selected in advance), so that data located at coordinates of line i and column j of the frame f(u) (where ‘i’ designates an integer not greater than ‘m’, and ‘j’ designates an integer not greater than ‘n’) is allocated to a packet p(u+(j−1)b+i) (where ‘b’ designates an integer representing a difference between adjacent data within the plurality of data of each frame and matching a prescribed number of packets).

6. The server adapted to a network system according to claim 5, wherein a plurality of data included in each packet are arranged in a matrix of m×n, so that data located at coordinates of line i and column j of the frame f(u) is allocated to coordinates of line i and column j of a packet p(u−1+(j−1)b+i).

7. A receiver terminal adapted to a network system in which a plurality of frames f(1), f(2), . . . , and f(u) are extracted from streaming contents and are distributed to a plurality of packets p(1), p(2), . . . , and p(u) and in which a plurality of data included in the frame f(u) are distributed to a plurality of packets p(u) to p(k+u−1) (where ‘u’ and ‘k’ designate integers), said receiver terminal receiving the plurality of packets, based on which the plurality of frames are restored so as to reproduce the streaming contents, wherein after completion of reception of the packets p(1) to p(k), the frame f(1) written in the packets is subjected to decoding so as to start reproducing the streaming contents.

8. The receiver adapted to a network system according to claim 7, wherein a plurality of data included in each frame are arranged in a matrix of m×n (where ‘m’ and ‘n’ designate integers selected in advance), so that data located at coordinates of line i and column j of the frame f(u) (where ‘i’ designates an integer not greater than ‘m’, and ‘j’ designates an integer not greater than ‘n’) is allocated to a packet p(u+(j−1)b+i) (where ‘b’ designates an integer representing a difference between adjacent data within the plurality of data of each frame and matching a prescribed number of packets).

9. The receiver terminal adapted to a network system according to claim 8, wherein a plurality of data included in each packet are arranged in a matrix of m×n, so that data located at coordinates of line i and column j of the frame f(u) is allocated to coordinates of line i and column j of a packet p(u−1+(j−1)b+i).

10. A data transmission system in which a server is connected with a receiver terminal via an Internet so as to perform broadcasting distribution of streaming contents, wherein a plurality of frames f(1), f(2), . . . , and f(u) are extracted from the streaming contents and are distributed to a plurality of packets p(1), p(2), . . . , and p(u), which are then transmitted onto the Internet by means of the server in such a way that a plurality of data included in the frame f(u) are distributed to a plurality of packets p(u) to p(k+u−1) (where ‘u’ and ‘k’ designate integers), and wherein the receiver terminal receives the plurality of packets, based on which the plurality of frames are restored so as to reproduce the streaming contents, in such a way that after completion of reception of the packets p(1) to p(k), the frame f(1) written in the packets is subjected to decoding so as to start reproducing the streaming contents.
